(19) United States
(12) Patent Application Publication
(10) Pub. No.: US 2011/0303764 A1
(43) Pub. Date: Dec. 15, 2011

(54) SPRINKLER HEAD ADAPTER FOR OUTDOOR LIGHT

(76) Inventor: Barry Roth, Aventura, FL (US)

(21) Appl. No.: 12/813,559

(22) Filed: Jun. 11, 2010

(51) Int. Cl. B05B 15/00; F16M 13/00; F21L 4/08; F21V 19/00; F21L 4/06

(52) U.S. Cl. 239/289; 362/382; 362/157; 362/183; 248/314

(57) ABSTRACT

An adapter for an outdoor light is disclosed. The adapter includes a hollow elongated element having a top end and a bottom end, a first opening at the top end of the elongated element, wherein the first opening accepts a shaft of the outdoor light to create a friction fit with the shaft, a second opening at the bottom end of the elongated element, wherein the second opening includes a projecting brim spanning only a portion of a circumference of the second opening and an inset lip coextensive with the projecting brim and extending from the projecting brim toward a center of the second opening.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention relates to accessories for outdoor lights, and more particularly to a universal adapter for coupling outdoor lights to a sprinkler head.

### BACKGROUND OF THE INVENTION

In recent years, outdoor lights have grown in popularity. The vast array of applications for outdoor lights has fueled their increasing sales. Outdoor lights can be used for aesthetic purposes in the design of gardens and yards, as well as for utilitarian purposes such as security, warding off insects or lighting dark paths. Various types of outdoor lights exist. A common type of outdoor light is the solar outdoor light, which consists of a solar element that charges a battery using energy garnered from a solar panel, a light emitting mechanism 102 (see FIG. 1) such as one or more LEDs, a base portion 104 comprising a shaft and a sharp stake 106 for inserting into the ground, wherein the stake is coupled to the base portion. Multiple outdoor solar lights can be placed along the foot of a garden path, for example, to light the way in the evening when there is no ambient light. Another common type of outdoor light is the electric outdoor light, which is similar to the solar outdoor light except that the electric outdoor light is connected to a power source via a power cord. Multiple outdoor electric lights can be strung together along the power cord to provide light to an outdoor area.

One problem that users of outdoor lights often encounter is the lack of options available when it comes to the location where an outdoor light is affixed. Since conventional outdoor lights usually come with a base portion that comprises a sharp stake for driving into the ground, users are limited to soft ground for the placement of outdoor lights. A sharp stake does not allow an outdoor light to be placed on hard ground, such as rocky terrain that does not allow a stake to be driven into it. Further, a sharp stake does not allow an outdoor light to be placed on a hard stationary object such as a fence post, a dock piling, a tree, a sprinkler head or any other stationary object comprised of a hard material that does not accept a sharp stake. This can be problematic to users of outdoor lights since soft ground is not always available in an outdoor area a user desires to illuminate. Furthermore, the addition of an outdoor light to a garden or outdoor area that already includes various accoutrements, including pavers, sprinklers, lawn ornaments, etc, can result in a cluttered garden. Current solutions, however, do not provide for the combination of garden accoutrements.

Therefore, a need exists to overcome the problems with the prior art as discussed above, and particularly for an apparatus that allows conventional outdoor lights to be coupled with already-existing objects in a garden or outdoor area.

### SUMMARY OF THE INVENTION

Briefly, in accordance with one embodiment of the present invention, an adapter for an outdoor light is disclosed. The adapter includes a hollow elongated element having a top end and a bottom end, a first opening at the top end of the elongated element, wherein the first opening accepts a shaft of the outdoor light to create a friction fit with the shaft, a second opening at the bottom end of the elongated element, wherein the second opening includes a projecting brim spanning only a portion of a circumference of the second opening and an inset lip coextensive with the projecting brim and extending from the projecting brim toward a center of the second opening.

In another embodiment of the present invention, an assembly for coupling an outdoor light to a sprinkler head is disclosed. The assembly includes a light emitting mechanism, a base portion of the light emitting mechanism comprising a cylindrical shaft, a tubular element having a top end and a bottom end, a first opening at the top end of the elongated element, wherein the first opening accepts the shaft of the outdoor light to create a friction fit with the shaft, a second opening at the bottom end of the elongated element, wherein the second opening includes a projecting brim spanning only a portion of a circumference of the second opening and an inset lip coextensive with the projecting brim and extending from the projecting brim toward a center of the second opening.

In another embodiment of the present invention, an assembly for coupling an outdoor light to a sprinkler head is disclosed. The assembly includes a sprinkler head comprising a cylindrical shape and having a ring-shaped gutter near a top of the sprinkler head, a tubular element having a top end and a bottom end, a first opening at the top end of the tubular element, wherein the first opening accepts a shaft of an outdoor light to create a friction fit with the shaft, a second opening at the bottom end of the tubular element, wherein the second opening includes a projecting brim spanning only a portion of a circumference of the second opening and an inset lip coextensive with the projecting brim and extending from the projecting brim toward a center of the second opening, wherein upon coupling of the sprinkler head to the tubular element, the projecting brim surrounds the sprinkler head and the inset lip projects into the gutter, so as to securely connect the sprinkler head to the tubular element.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a frontal view of a prior art outdoor light.

FIG. 2 is an illustration of a frontal view, including a partial cross section, of an assembly for coupling an outdoor light to a sprinkler head, in accordance with one embodiment of the present invention.

FIG. 3 is an illustration of a cross sectional view of the universal adapter of FIG. 2 for coupling an outdoor light to a sprinkler head, in accordance with one embodiment of the present invention.

FIG. 4A is an illustration of a perspective view of the universal adapter of FIG. 2 for coupling an outdoor light to a sprinkler head, in accordance with one embodiment of the present invention.

FIG. 4B is an illustration of a perspective view of an alternative embodiment of the universal adapter of FIG. 2 for coupling an outdoor light to a sprinkler head, in accordance with one embodiment of the present invention.

FIG. 5 is an illustration of a perspective view, including a partial cross section, of the assembly for coupling an outdoor light to a sprinkler head, in accordance with one embodiment of the present invention.

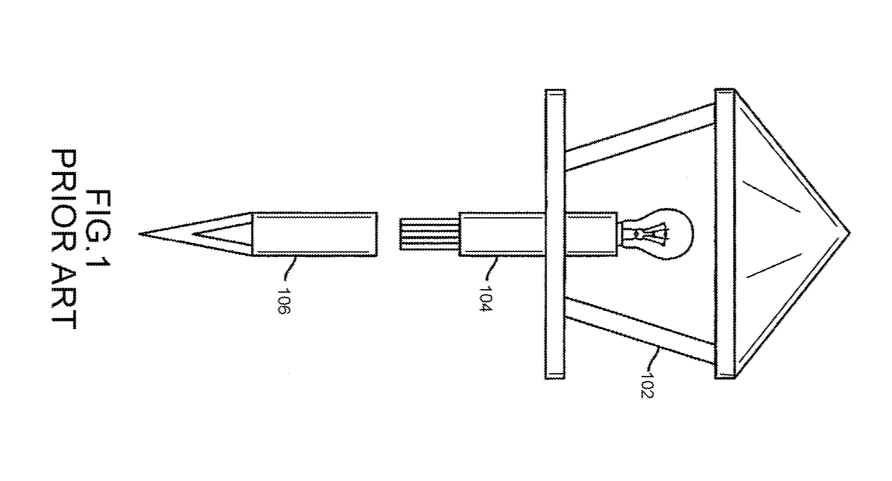

### DETAILED DESCRIPTION

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing like numerals refer to like parts through several views.

The present invention, according to a preferred embodiment, overcomes problems with the prior art by providing a universal adapter for securely coupling commercially available outdoor lights to commercially available sprinkler heads. The present invention further solves problems with the prior art by providing an adapter apparatus that provides a secure, though easily removable, coupling between the outdoor light and the sprinkler head, wherein the coupling is a friction fit without any moving parts. Further, the present invention solves problems with the prior art by providing an adapter apparatus that fits various types of outdoor lights while also fitting most, if not all, commercially available sprinkler heads, thereby providing a universal apparatus that can be used with a variety of outdoor lights and sprinkler heads. Lastly, the present invention solves problems with the prior art by providing an adapter apparatus that allows outdoor lights to be coupled with sprinkler heads, thereby reducing clutter due to garden accoutrements and producing an aesthetically pleasing display when light from the outdoor light interacts with water expelled from the sprinkler

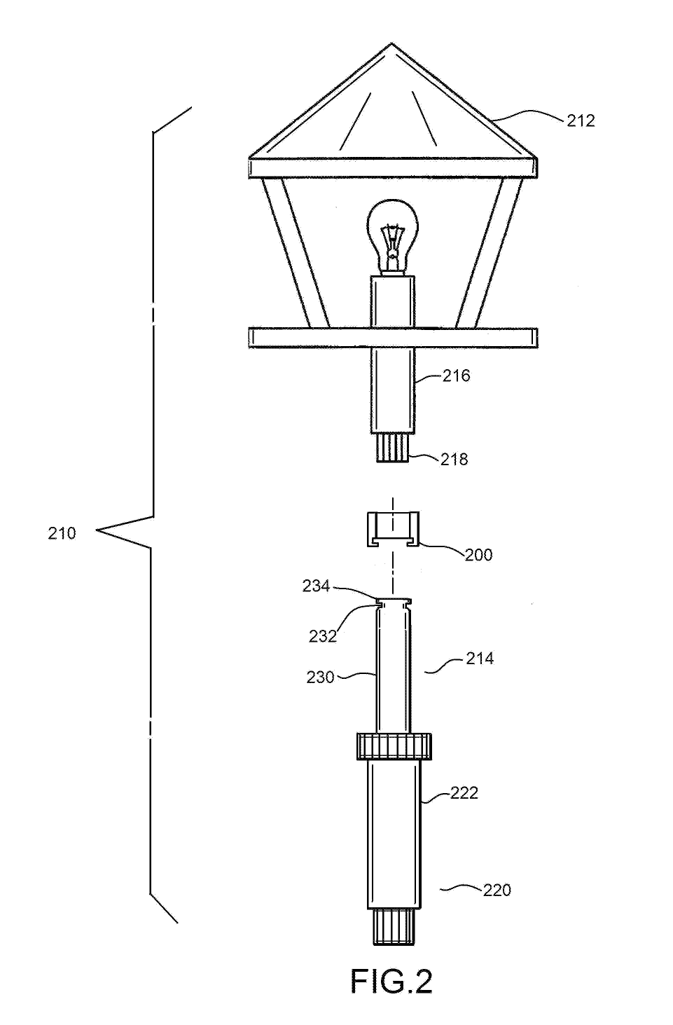

FIG. 2 is an illustration of a frontal view, including a partial cross section, of an assembly 210 for coupling an outdoor light 212 to a sprinkler head 214, in accordance with one embodiment of the present invention. FIG. 2 shows an outdoor light 212 including a base portion 216 and a cylindrical shaft 218. The outdoor light 212 may comprise a solar outdoor light powered via a battery that is charged by a solar panel. Alternatively, outdoor light 212 may be an electric outdoor light that is powered via a wire that is coupled to a power outlet.

FIG. 2 also shows a pop-up sprinkler 220 comprising a base 222 and a sprinkler head 214 that pops up or raises itself out of the base 222 when water pressure builds up within the interior cavity of the sprinkler 220. Pop-sprinklers typically include a spring-action that retracts the sprinkler head 214 into the base 222 when water pressure subsides within the interior cavity of the sprinkler 220.

The conventional sprinkler head 214 comprises a shaft 230 with a relatively uniform thickness but having a reduced circumference at détente 232. The détente 232 is a ring-shaped gutter that runs just below the top of the shaft 230. Above détente 232, however, a protrusion 234 includes a circumference greater than détente 232 and equal to or greater than the circumference of shaft 230. Typically, an orifice for allowing water to escape the sprinkler heard 214 is located at the bottom or lower portion of the détente 232.

FIG. 2 further shows the universal adapter 200 for securely coupling the light 212 to the sprinkler head 214. Greater detail about universal adapter 200 is provided with reference to the figures below.

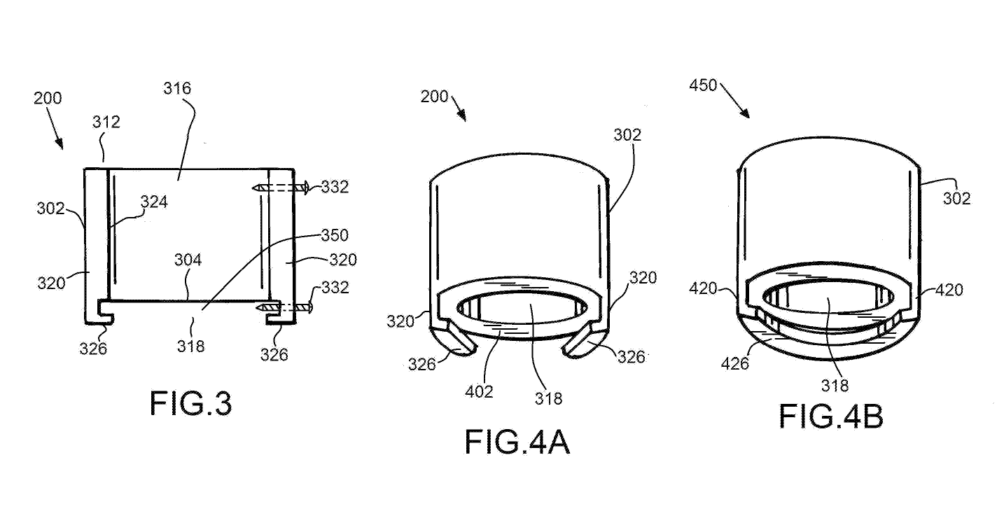

FIG. 3 is an illustration of a cross sectional view of the universal adapter 200 of FIG. 2 for coupling an outdoor light 212 to a sprinkler head 214, in accordance with one embodiment of the present invention. FIG. 3 shows that adapter 200 includes a hollow tubular elongated element 302 having a top end 312 and a bottom end 314. A first opening 316 at the top end 312 of the elongated element 302, accepts a shaft 218 of an outdoor light 212 to create a friction fit with the shaft 218. A second opening 318 at the bottom end 314 of the elongated element 302 includes a projecting rim 320 and an inset lip 326 that protrudes towards the center of the opening 318. The smaller diameter of the inset lip 326 produces a slot shaped opening 350 when viewed from the side. This, as explained in greater detail below, allows the protrusion 234 of the sprinkler head 214 to be slid into the slot 350 when attaching the sprinkler head 214 to the adapter 200. When such a coupling is made, the projecting rim 320 surrounds the protrusion 234 and the inset lip 326 juts into the détente 326 so as to grasp the top of the sprinkler head 214.

FIG. 3 further shows a plug 304 located at substantially a midpoint of an interior of the elongated element 302, wherein the plug 304 comprises substantially a disk that contacts an interior surface 324 of the elongated element 302. In one embodiment, the plug 304 may be integrally formed with the tubular element 302.

FIG. 3 further shows a set screw 332 located near the top end 312 of the elongated element 302, wherein the set screw 332 secures the shaft 218 to the elongated element 302 when the shaft is inserted into the elongated element 302 and the set screw 332 is tightened so as to further penetrate the elongated element 302. FIG. 3 also shows a set screw 331 located near the bottom end 314 of the elongated element 302, wherein the set screw 331 secures the sprinkler head 234 to the elongated element 302 when the sprinkler head is inserted into the elongated element 302 and the set screw 331 is tightened so as to further penetrate the elongated element 302.

In one embodiment of the present invention, elements 302 and 304 can be formed as one integral part. In another embodiment, elements 302, 304 are formed as two separate and substantially equal halves (wherein the device of FIG. 3 is split in two halves with a vertical separation extending down the middle of the device). In this embodiment, the two halves of the device of FIG. 3 are coupled using tabs or another fastening apparatus.

FIG. 4A is an illustration of a perspective view of the universal adapter 200 of FIG. 2 for coupling an outdoor light 212 to a sprinkler head 214, in accordance with one embodiment of the present invention. FIG. 4A shows the tubular element 302 and second opening 318 at the bottom end 314 of the tubular element 302. FIG. 4A further shows a pair of projecting rims 320, which project from the tubular element 302, and a pair of an inset lips 326 that protrude towards the center of the opening 318. Each inset lip is coextensive with its respective projecting rim. Note that each projecting rim 320 spans about forty five degrees of the circumference of the opening 318 and that the pair of projecting rims 320 are opposite each other around the circumference of the opening 318. Likewise, the placement of the pair of inset lips 326 is similarly situated opposite each other around the circumference of the opening 318.

Note also that FIG. 4A shows striations or texture etchings 402 that have been inscribed into the bottom-facing surface of the tubular element 302. This provides traction that allows for a better friction fit when the protrusion 234 of the sprinkler head 214 is slid into the slot 350 during coupling of the sprinkler head 214 to the adapter 200. In such a connection, the top surface of the sprinkler head 214 contacts the bottom-facing surface of the tubular element 302. Thus, the placement of the striations or texture etchings 402 upon the bottom-facing surface of the tubular element 302 provides a more secure connection between the top surface of the sprinkler head 214 and the bottom-facing surface of the tubular element 302. This, in turn, provides a more secure fit between the adapter 200 and the light 212.

FIG. 4B is an illustration of a perspective view of an alternative embodiment 450 of the universal adapter 200 of FIG. 2 for coupling an outdoor light 212 to a sprinkler head 214, in accordance with one embodiment of the present invention. FIG. 4B shows the tubular element 302 and second opening 318 at the bottom end 314 of the tubular element 302. FIG. 4B further shows a singular, continuous projecting rim 420, which projects from the tubular element 302, and a singular, continuous inset lip 426 that protrudes towards the center of the opening 318. Note that the projecting rim 420 spans about one hundred and eighty degrees of the circumference of the opening 318 and likewise the pair of inset lips 326 spans about one hundred and eighty degrees of the circumference of the opening 318.

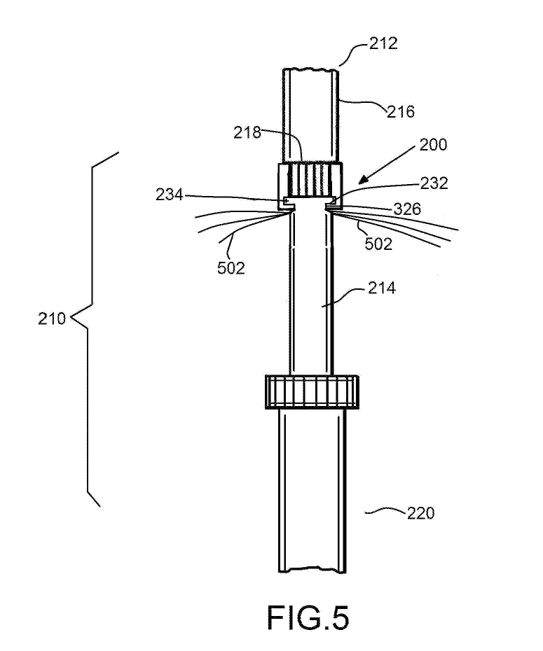

FIG. 5 is an illustration of a frontal view, including a partial cross section, of the assembly 210 for coupling an outdoor light 212 to a sprinkler head 214, in accordance with one embodiment of the present invention. FIG. 5 shows that shaft 218 of outdoor light 212 is inserted into opening 316 of the adapter 200, thereby providing a friction fit between the outdoor light 212 and the adapter 200. FIG. 5 further shows that the protrusion 234 of sprinkler 214 may slide, in a lateral or sideways motion, into the slot 350. The inset lip 326 juts into the détente 232 and therefore grasps the sprinkler head 214, preventing it from moving upwards. Note that the inset lip 326 juts only into the top or upper portion of the détente 232, thereby allowing the orifice for egress of water 502 to continue operating.

Thusly, the inset lip 326 grasps the détente 232 of sprinkler head 214, thereby producing a secure connection between the adapter 200 and the sprinkler head 214. By extension, a secure connection thereby exists between the light 212 and the sprinkler 220. Furthermore, when water 502 is expelled from the sprinkler 220 and interacts with light emanating from the outdoor light 212, an aesthetically pleasing display is produced.

Elements 302 and 304 may be manufactured from a variety of materials including metal, such as stainless steel, titanium, aluminum or any metal alloy, rigid fabric, carbon fiber, epoxy resin, graphite, rubber, plastic or any combination of the above.

Plastic covers a range of synthetic or semi-synthetic polymerization products. Plastics are composed of organic condensation or addition polymers and may contain other substances to improve performance or economics. In the present invention, plastic may comprise any one of the following forms of plastic: polyethylene, polystyrene, high impact polystyrene, polyethylene terephthalate, nylon, polypropylene, acrylonitrile butadiene styrene (ABS), bayblend and polyvinylidene chloride (PVC).

Elements 302 and 304 may be manufactured from a plastic compound using any variety of processes, such as injection molding, fusible core injection molding and thermoforming.

Injection molding is a manufacturing technique for making parts from thermoplastic material in production. Molten plastic is injected at high pressure into a mold, which is the inverse of the product's shape. After a product is designed by an industrial designer, molds are made by a mold-maker from metal, usually either steel or aluminum, and precision-machined to form the features of the desired part. Injection molding is widely used for manufacturing a variety of parts and is the most common method of plastic production.

The most commonly used thermoplastic materials are polystyrene, ABS or acrylonitrile butadiene styrene, nylon, polypropylene, polyethylene, and polyvinyl chloride or PVC.

Injection molding machines, also known as presses, hold the molds in which the components are shaped. Presses are rated by tonnage, which expresses the amount of clamping force that the machine can generate. This pressure keeps the mould closed during the injection process.

Molds separate into at least two halves (called the core and the cavity) to permit the plastic part to be extracted. In general, the shape of a part must not cause it to be locked into the mould. For example, sides of objects typically cannot be parallel with the direction of draw (the direction in which the core and cavity separate from each other). They are angled slightly. Pins are the most popular method of removal from the core, but air ejection, and stripper plates can also be used depending on the application. Most ejection plates are found on the moving half of the tool, but they can be placed on the fixed half.

Molds are built through two main methods: standard machining and EDM machining Standard machining, in its conventional form, has historically been the method of building injection molds. With technological development, computer numerical control (CNC) machining became the predominant means of making more complex molds with more accurate mold details in less time than traditional methods.

The electrical discharge machining (EDM) or spark erosion process has become widely used in mold making. EDM is a simple process in which a shaped electrode, usually made of copper or graphite, is very slowly lowered onto the mould surface (over a period of many hours), which is immersed in paraffin oil. A voltage applied between tool and mould causes erosion of the mould surface in the inverse shape of the electrode.

Fusible core injection molding or lost core injection molding is a specialized plastic injection molding process. It is used in the manufacture of molded components with cavities or undercuts, which would not be possible with tools having demoldable cores. The process consists of three essential steps. First, a core consisting of a low melting point metal is poured in the shape of the cavity specified for the molded component. This is inserted into the injection mold in the second step and injected with plastic. Molded component and core are both demolded and, in the third step, immersed in a heated bath to melt out the core. The bath temperature is selected to be somewhat higher than that of the core alloy's melting point, but not so that the injected part would be damaged. Induction heating of the core metal in the heated bath reduces the melt out time to a few minutes. Liquid core metal collects on the bottom of the heated bath and is usable for a new core.

Thermoforming is a manufacturing process for thermoplastic sheet or film. The sheet or film is heated between infrared, natural gas, or other heaters to its forming temperature. Then it is stretched over or into a temperature-controlled, single-surface mold. Cast or machined aluminum is the most common mold material, although epoxy and wood tooling are sometime used for low volume production. The sheet is held against the mold surface unit until cooled. The formed part is then trimmed from the sheet. The trimmed material is usually reground, mixed with virgin plastic, and reprocessed into a usable sheet. There are several categories of thermoforming, including vacuum forming, pressure forming, twin-sheet forming, drape forming, free blowing, and simple sheet bending.

In one embodiment of the present invention, elements 302, 304 may be manufactured from a material that dissipates or insulates the heat created by the accompanying outdoor light during use. The material used to manufacture the elements 302, 304, such as plastic, may possess heat isolative properties that prevent the exterior of apparatus 200 from overheating. Alternatively, the material used to manufacture the elements 302, 304, such as metal, may possess heat conductive properties that quickly dissipate the heat originating from the light mechanism. Alternatively, the material used to manufacture the elements 302, 304 may possess any combination of heat insulating and heat conducting properties so as to accomplish the goal of re-directing the heat emanating from the light mechanism so as not to harm humans or animals that may contact the apparatus. Such redirection of the laptop heat is beneficial as it reduces or eliminates the negative implications of high temperatures that may harm living organisms including animals and plant life.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. An adapter for an outdoor light, comprising:
a hollow elongated element having a top end and a bottom end;
a first opening at the top end of the elongated element, wherein the first opening accepts a shaft of the outdoor light to create a friction fit with the shaft;
a second opening at the bottom end of the elongated element, wherein the second opening includes a projecting brim spanning only a portion of a circumference of the second opening; and
an inset lip coextensive with the projecting brim and extending from the projecting brim toward a center of the second opening.

2. The adapter of claim 1, wherein the hollow elongated element comprises a tube having a circular-shaped cross section.

3. The adapter of claim 2, wherein the first opening is a circular-shaped opening.

4. The adapter of claim 3, wherein the second opening is a circular-shaped opening.

5. The adapter of claim 4, wherein the projecting brim spans about forty five degrees of the circumference of the second opening.

6. The adapter of claim 5, further comprising a second projecting brim spanning about forty five degrees of the circumference of the second opening and located opposite from the first projecting brim about the circumference of the second opening.

7. The adapter of claim 6, further comprising a second inset lip coextensive with the second projecting brim and extending from the second projecting brim toward the center of the second opening.

8. The adapter of claim 4, wherein the projecting brim spans about one hundred and eighty degrees of the circumference of the second opening.

9. An assembly for coupling an outdoor light to a sprinkler head, comprising:
a light emitting mechanism;
a base portion of the light emitting mechanism comprising a cylindrical shaft;
a tubular element having a top end and a bottom end;
a first opening at the top end of the elongated element, wherein the first opening accepts the shaft of the outdoor light to create a friction fit with the shaft;
a second opening at the bottom end of the elongated element, wherein the second opening includes a projecting brim spanning only a portion of a circumference of the second opening; and
an inset lip coextensive with the projecting brim and extending from the projecting brim toward a center of the second opening.

10. The assembly of claim 9, wherein the projecting brim spans about forty five degrees of the circumference of the second opening.

11. The assembly of claim 10, further comprising a second projecting brim spanning about forty five degrees of the circumference of the second opening and located opposite from the first projecting brim about the circumference of the second opening.

12. The adapter of claim 11, further comprising a second inset lip coextensive with the second projecting brim and extending from the second projecting brim toward the center of the second opening.

13. The assembly of claim 9, wherein the projecting brim spans about one hundred and eighty degrees of the circumference of the second opening.

14. The assembly of claim 9, further comprising:
a wire coupled to a power outlet, wherein the light emitting mechanism is powered by a current provided via the wire.

15. The assembly of claim 9, further comprising:
a set screw located near the top end of the tubular element, wherein the set screw secures the shaft to the tubular element.

16. The assembly of claim 9, further comprising:
a solar panel for charging a battery that powers the light emitting mechanism.

17. An assembly for coupling an outdoor light to a sprinkler head, comprising:
a sprinkler head comprising a cylindrical shape and having a ring-shaped gutter near a top of the sprinkler head,
a tubular element having a top end and a bottom end;
a first opening at the top end of the tubular element, wherein the first opening accepts a shaft of an outdoor light to create a friction fit with the shaft;
a second opening at the bottom end of the tubular element, wherein the second opening includes a projecting brim spanning only a portion of a circumference of the second opening; and
an inset lip coextensive with the projecting brim and extending from the projecting brim toward a center of the second opening, wherein upon coupling of the sprinkler head to the tubular element, the projecting brim surrounds the sprinkler head and the inset lip projects into the gutter, so as to securely connect the sprinkler head to the tubular element.

18. The assembly of claim 18, wherein the projecting brim spans about forty five degrees of the circumference of the second opening.

19. The assembly of claim 18, further comprising a second projecting brim spanning about forty five degrees of the circumference of the second opening and located opposite from the first projecting brim about the circumference of the second opening.

20. The adapter of claim 19, further comprising a second inset lip coextensive with the second projecting brim and extending from the second projecting brim toward the center of the second opening.
